(19) United States
(12) Patent Application Publication
(10) Pub. No.: US 2022/0251306 A1
(43) Pub. Date: Aug. 11, 2022

(54) PROVIDING FIBER SUBSTRATES WITH A WASH-RESISTANT FINISH WITH SILICON COPOLYMERS

(71) Applicant: WACKER CHEMIE AG, Munich (DE)

(72) Inventors: Jens-Peter MOLDENHAUER, Burghausen (DE); Walter EICHBERGER, Kirchberg (AT); Inge SEEGER-FEICHTINGER, Simbach am Inn (DE)

(73) Assignee: WACKER CHEMIE AG, Munich (DE)

(21) Appl. No.: 17/611,147

(22) PCT Filed: May 15, 2019
(86) PCT No.: PCT/EP2019/062529

§ 371 Date: Nov. 13, 2021

(51) Int. Cl. C08G 77/46; C08K 5/06; D06M 15/643

(52) U.S. Cl. CPC C08G 77/46; C08K 5/06; D06M 2200/50; D06M 15/6433; D06M 15/6436

(57) ABSTRACT

Organopolysiloxane copolymers having the formula

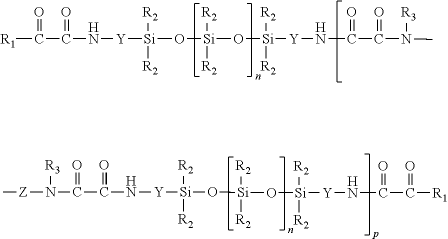

are useful in treating fibrous substances, particularly textile fabrics, to produce a laundering-resistant soft hand.

### CROSS REFERENCE TO RELATED APPLICATIONS

This application is the U.S. National Phase of PCT Appln. No. PCT/EP2019/062529 filed May 15, 2019, the disclosure of which is incorporated in its entirety by reference herein.

### BACKGROUND OF THE INVENTION

### 1. Field of the Invention

The invention relates to the use of silicone copolymers for the laundry-durable finishing of fibrous substrates.

### 2. Description of the Related Art

Modern, silicone-containing softeners for imparting water repellency to fibers consist primarily of functional silicone oils which comprise, for example, hydrophilic groups or quaternary ammonium groups, as known from DE 19652524 A1, for example. The quaternary products are usually not water-soluble, and have to be brought into an aqueous applicable form by additional emulsification, whereas the hydrophilically modified siloxanes are partially water-dispersible. The latter, however, by comparison with conventional amino-functional siloxanes, have poorer softening qualities.

Siloxane copolymers, as described in U.S. Pat. No. 5,001,210 A, US 2003/0032726 A1 and US 2008/0075683 A1, in which the amino groups are combined with hydrophilic groups, display the disadvantage of being necessarily prepared in multistage synthesis steps. In these syntheses, in some cases, toxic intermediates, such as isocyanates and their derivatives, have to be used and/or are obtained as intermediates, or costly and inconvenient hydrosilylation steps are needed. The hydrophilic products, furthermore, are not laundry-resistant and nor can they be given such modification in an economical way. In some cases, furthermore, they exhibit an interfering intrinsic color.

U.S. Pat. No. 7,501,184 describes copolymers which are obtained by reaction of linear organopolysiloxanes, terminated with oxamidoester groups, with organic diamines. The copolymers obtained, which have a high viscosity or are solid, are used in adhesives, especially as hotmelt adhesives. These high-viscosity products are not stably emulsifiable and therefore cannot be integrated into the textile application chain.

The object was to provide silicone copolymers and emulsions thereof for use in the treatment of fibrous substrates, especially textiles, that do not have the above-stated disadvantages and can be prepared without toxic substances, such as isocyanates, for finishing the treated substrates with an improved laundry resistance.

The object is achieved by the invention.

### SUMMARY OF THE INVENTION

A subject of the invention is the use, for the laundry-durable finishing of fibrous substrates, of compositions comprising silicone copolymers (A) of the formula (I)

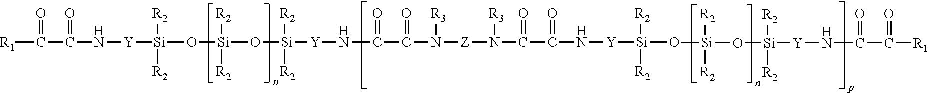

where
Y is identical or different and denotes a divalent hydrocarbon radical which has 1 to 20 carbon atoms and may comprise one or more heteroatoms, preferably oxygen or nitrogen atoms,
Z is identical or different and denotes an organic radical which contains a polyoxyalkylene group and is divalent, preferably a radical of the formula —(R⁶O)_{w}—R⁷—,
R¹ is identical or different and is a radical of the formula —N(R⁴)—R⁵ (IV′) or —O—R⁵ (V′), preferably a radical of the formula —N(R⁴)—R⁵ (IV′),
R² is identical or different and denotes a monovalent hydrocarbon radical which has 1 to 18 carbon atoms and may comprise halogen or oxygen atoms,
R³ is identical or different and is a hydrogen atom or a monovalent hydrocarbon radical having 1 to 20 carbon atoms,
R⁴ denotes a hydrogen atom, a C₁₋₁₈ alkyl radical or a hydrocarbon radical which has 4 to 18 carbon atoms and comprises one or more oxygen or nitrogen atoms, and
R⁵ is a C₁₋₁₈ alkyl radical or a hydrocarbon radical which has 4 to 18 carbon atoms and comprises one or more oxygen or nitrogen atoms, or R⁴ and R⁵ in formula (IV′) together denote a divalent hydrocarbon radical which may comprise one or more oxygen or nitrogen atoms,
R⁶ is identical or different and denotes a C₁-C₁₀ alkylene radical, preferably a C₂-C₃ alkylene radical, more preferably an ethylene or isopropylene radical, and
R⁷ denotes a C₁-C₁₀ alkylene radical, preferably a C₂-C₃ alkylene radical, more preferably an ethylene or isopropylene radical,
n is an integer from 10 to 2000, preferably 10 to 300,
p is an integer from 1 to 5, preferably 1 to 2, more preferably 1, and
w is on average 2.5 to 80, preferably 10 to 30.

### DETAILED DESCRIPTION OF THE PREFERRED EMBODIMENTS

The silicone copolymers of the invention for the laundry-durable finishing of fibrous substrates are prepared by reacting
(1) organopolysiloxanes terminated with oxamidoester groups, of the formula (II)

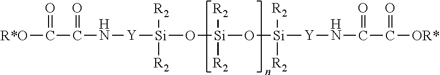

where R², Y and n have the definition indicated for them above and
R* is a monovalent hydrocarbon radical having 1 to 18 carbon atoms or is a radical R⁵, where R⁵ has the definition indicated for it above, with
(2) polyetheramines of the formula

R³HN—Z—NHR³ (III),
where R³ and Z have the definition indicated for them above, and with
(3) primary or secondary amines of the formula

H—N(R⁴)—R⁵ (IV)
or alcohols of the formula H—O—R⁵(V),
where R⁴ and R⁵ have the definition indicated for them above.

The silicone copolymers of the invention for the laundry-durable finishing of fibrous substrates differ from the high molecular copolymers described in U.S. Pat. No. 7,501,184 in having a much lower molecular weight. The silicone copolymers preferably have a molecular weight Mn (number average) of 4000-30 000 g/mol.

This number-average molecular weight Mn is determined for the purposes of the present invention preferably by size exclusion chromatography (SEC). The number-average molecular weight Mn is determined preferably by size exclusion chromatography (SEC) against polystyrene standards, in THF, at 60° C., flow rate 1.2 ml/min, and detection by RI (refractive index detector) on a Styragel HR3-HR4-HR5-HR5 column set from Waters Corp. USA, with an injection volume of 100 μl.

Examples of the radical Y are divalent hydrocarbon radicals such as the methylene group, the 1,2-ethylene group, the 1,3-propylene group, the 1,3-butylene group, the 1,4-butylene group, the 1,5-pentylene group and the 1,6-hexylene group.

Further examples of the radical Y are alkylene radicals which contain one or more heteroatoms, such as, for example, the —C₂H₄—NH—C₃H₆— group.

A preferred example is the 1,3-propylene group.

Examples of the radical Z are divalent hydrocarbonoxy radicals, such as the polyethylene glycol radicals or polypropylene glycol radicals or mixtures of polyethylene glycol and polypropylene glycol radicals. The radical Z preferably has a molecular weight of 120 g/mol to 4500 g/mol, very preferably a molecular weight of 500 g/mol to 1800 g/mol.

Examples of radicals R² are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; alkenyl radicals, such as the vinyl, 5-hexenyl, cyclohexenyl, 1-propenyl, allyl, 3-butenyl and 4-pentenyl radical; alkynyl radicals, such as the ethynyl, propargyl and 1-propynyl radical; aryl radicals, such as the phenyl, naphthyl, anthryl and phenanthryl radical; alkaryl radicals, such as o-, m- and p-tolyl radicals, xylyl radicals and ethylphenyl radicals; and aralkyl radicals, such as the benzyl radical, the α- and the β-phenylethyl radical.

A preferred example of the radical R² is the methyl radical.

The radicals R² stated above may also contain one or more halogen atoms or oxygen atoms.

Examples of hydrocarbon radicals R² are also valid for hydrocarbon radicals R³. R³ is preferably a hydrogen atom or C₁-C₆ alkyl radical, more preferably a hydrogen atom.

The radical R¹ of the formula —N(R⁴)—R⁵ (IV′) originates from a primary or secondary amine of the formula H—N(R⁴)—R⁵ (IV) minus the H atom bonded on the nitrogen atom.

The radical R¹ of the formula —O—R⁵ (V′) originates from an alcohol of the formula H—O—R⁵ (V) minus the H atom bonded on the oxygen atom.

The radicals R⁴ and R⁵ in the radical R¹ may be identical or different C₁-C₁₈ alkyl radicals. The examples of C₁-C₁₈ alkyl radicals R² are also valid for C₁-C₁₈ alkyl radicals R⁴ and R⁵. R⁴ and R⁵ in formula (IV′) may simultaneously be part of a cyclic radical.

The radicals R⁴ and R⁵ in the radical R¹ may also denote a hydrocarbon radical having 4 to 18 carbon atoms and preferably comprising at least one nitrogen or oxygen heteroatom. R⁴ and R⁵ in this case in formula (IV′) may simultaneously be part of a heterocyclic radical.

Examples of such radicals R⁴ and R⁵ are radicals of the formula —(CH₂)₃—N(CH₃) 2, —(CH₂)₃—OCH₂CH₃ and—(CH₂)₂—OCH₂CH₃.

Preferred examples of amines of the formula H—N(R⁴)—R⁵ (IV) are primary amines, such as
H—NH—(CH₂)₃—N(CH₃)₂
(N¹,N¹-dimethylpropane-1,3-diamine)

and secondary amines, such as
H—N—[(CH₂)₃—N(CH₃)₂]₂
(N¹-(3-(dimethylamino)propyl)-N³,N³-dimethylpropane-1,3-diamine)

primary polyether amines such as
H—NH—(CH₂)₃—OCH₂CH₃, H—NH—(CH₂)₂—OCH₂CH₃,

secondary polyether amines such as
NH— [(CH₂)₃—OCH₂CH₃]₂, NH—[(CH₂)₂-OCH₂CH₃]₂.

The preferred radicals R¹ here correspond to the above-stated amines minus one H atom bonded on the nitrogen atom N, or to the above-stated alcohols minus one O atom bonded on the oxygen atom O,

and hence preferred radicals R¹ are those of the formula
NH—(CH₂)₃—N(CH₃) 2 and NH—(CH₂)₃—OCH₂CH₃
—N—[(CH₂)₃—N(CH₃) 212 and —N—[(CH₂)₃—OCH₂CH₃]₂.

The compositions of the invention for the laundry-durable finishing of fibrous substrates may be solutions of silicone copolymers (A) of the invention in organic solvents.

The compositions of the invention for the laundry-durable finishing of fibrous substrates are preferably aqueous emulsions comprising

silicone copolymers (A) of the invention,

emulsifiers (B) and/or coemulsifiers (B′) and

water (C).

Emulsifiers (B) used may be nonionic, anionic or cationic emulsifiers or else mixtures thereof.

The aqueous emulsions of the invention for the laundry-durable finishing of fibrous substrates comprise emulsifiers that are known per se, and mixtures thereof.

Particularly suitable anionic emulsifiers include:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) and/or propylene oxide (PO) units.

2. Sulfonates, particularly alkylsulfonates having 8 to 18 carbon atoms, alkylarylsulfonates having 8 to 18 carbon atoms, taurides, esters and monoesters of sulfosuccinic acid with monohydric alcohols or alkylphenols having 4 to 15 carbon atoms; these alcohols or alkylphenols may optionally also be ethoxylated with 1 to 40 EO units.

3. Alkali metal salts and ammonium salts of carboxylic acids having 8 to 20 carbon atoms in the alkyl, aryl, alkaryl or aralkyl radical.

4. Phosphoric acid partial esters and their alkali metal and ammonium salts, particularly alkyl and alkaryl phosphates having 8 to 20 carbon atoms in the organic radical, alkyl ether and alkaryl ether phosphates having 8 to 20 carbon atoms in the alkyl or alkaryl radical, respectively, and 1 to 40 EO units.

Particularly suitable nonionic emulsifiers include:

5. Polyvinyl alcohol additionally having 5 to 50%, preferably 8 to 20%, of vinyl acetate units, with a degree of polymerization of 500 to 3000.

6. Alkyl polyglycol ethers, preferably those having 8 to 40 EO units and alkyl radicals of 8 to 20 carbon atoms.

7. Alkylaryl polyglycol ethers, preferably those having 8 to 40 EO units and 8 to 20 carbon atoms in the alkyl and aryl radicals.

8. Ethylene oxide/propylene oxide (EO/PO) block copolymers, preferably those having 8 to 40 EO and PO units.

9. Adducts of alkylamines having alkyl radicals of 8 to 22 carbon atoms with ethylene oxide or propylene oxide.

10. Fatty acids having 6 to 24 carbon atoms.

11. Alkyl polyglycosides of the general formula R*—O—Zₒ, in which R* denotes a linear or branched, saturated or unsaturated alkyl radical having on average 8-24 carbon atoms and Zₒ denotes an oligoglycoside radical having on average o=1-10 hexose or pentose units or mixtures thereof.

12. Natural substances and their derivatives, such as lecithin, lanolin, saponins, cellulose; cellulose alkyl ethers and carboxyalkylcelluloses in which the alkyl groups each possess up to 4 carbon atoms.

13. Linear organo(poly)siloxanes containing polar groups, especially those with alkoxy groups having up to 24 carbon atoms and/or up to 40 EO and/or PO groups.

Particularly suitable cationic emulsifiers include:

14. Salts of primary, secondary and tertiary fatty amines having 8 to 24 carbon atoms with acetic, sulfuric, hydrochloric and phosphoric acids.

15. Quaternary alkylammonium and alkylbenzeneammonium salts, more particularly those whose alkyl groups possess 6 to 24 carbon atoms, especially the halides, sulfates, phosphates and acetates.

16. Alkylpyridinium, alkylimidazolinium and alkyloxazolinium salts, more particularly those whose alkyl chain possesses up to 18 carbon atoms, especially the halides, sulfates, phosphates and acetates.

Particularly suitable ampholytic emulsifiers include:

17. Amino acids with long-chain substitution, such as N-alkyldi(aminoethyl)glycine or salts of N-alkyl-2-aminopropionic acid.

18. Betaines, such as N-(3-acylamidopropyl)-N,N-dimethylammonium salts having a C₈-C₁₈ acyl radical, and alkylimidazolium betaines.

Preferred emulsifiers are nonionic emulsifiers, especially the alkyl polyglycol ethers listed above under 6., the adducts of alkylamines with ethylene oxide or propylene oxide, listed under 9., the alkyl polyglycosides listed under 11., and the polyvinyl alcohols listed under 5.

Emulsifiers are used here in amounts of 1 wt % to 70 wt %, based on the total weight of the aqueous emulsions.

The aqueous emulsions for the laundry-durable finishing of fibrous substrates comprise copolymers (A) of the invention preferably in amounts of 0.5 wt % to 80 wt %, based on the total weight of the aqueous emulsions.

The aqueous emulsions of the invention for the laundry-durable finishing of fibrous substrates may also comprise further substances, such as polyethylene glycols, polypropylene glycols and polyethylene-polypropylene glycols and mixtures thereof, and also acids. Examples of acids are carboxylic acids, such as acetic acid, formic acid, citric acid, malic acid and lactic acid.

Further substances that may be present in the aqueous emulsions of the invention for the laundry-durable finishing of fibrous substrates include solvents or coemulsifiers (B′).

Examples of nonaqueous solvents or coemulsifiers are 1-pentanol, 1-hexanol, 1-octanol, propanediol, 1,3-butanediol, 1,2-hexanediol, 2-ethylhexane-1,3-diol, 1,2-octanediol, glycerol, diethylene glycol methyl ether, diethylene glycol ethyl ether, diethylene glycol mono-n-butyl ether, propylene glycol methyl ether.

The oxamidoester group-terminated organopolysiloxanes (1) of the formula (II) that are used in the preparation of silicone copolymers for the laundry-durable finishing of fibrous substrates may be prepared by the process described in U.S. Pat. No. 7,501,184 B2 (incorporated by reference), especially column 13, lines 14 to 48. The skilled person is also aware of other processes.

Examples of the polyetheramines (2) used in the preparation of silicone copolymers for the laundry-durable finishing of fibrous substrates are Jeffamine® diamines of series D and ED, available commercially from Huntsman, such as Jeffamine® D-230, Jeffamine® D-400, Jeffamine® D-2000, Jeffamine® HK 511, Jeffamine® ED-600, Jeffamine® ED-900 and Jeffamine® ED-2003.

The preparation of silicone copolymers for the laundry-durable finishing of fibrous substrates uses polyetheramines (2) in amounts of preferably 0.3 to 0.8 mol, preferably 0.4 to 0.6, more preferably 0.5 mol, of amino group in (2) per mole of oxamidoester group in organopolysiloxane (1).

Employed preferably as component (3) are primary or secondary amines of the formula (IV).

The preparation of silicone copolymers for the laundry-durable finishing of fibrous substrates uses primary or secondary amines (3) in amounts of preferably 0.2 to 0.7 mol, more preferably 0.4 to 0.6 mol, very preferably 0.5 mol, of amino group in (3) per mole of oxamidoester group in organopolysiloxane (1).

The oxamidoester groups present in organopolysiloxane (1) are reacted preferably to an extent of at least 80%, more preferably at least 90%, very preferably at least 95% with the amino groups contained in (2) and (3).

In the preparation of silicone copolymers for the laundry-durable finishing of fibrous substrates, the organopolysiloxanes (1) terminated with oxamidoester groups are preferably introduced initially, and the polyetheramines (2) and the amines (3) can be added together, or the amines (3) can first be added and then the polyetheramines (2), or the polyetheramines (2) can first be added and then the amines (3).

Preference is given to adding first the amines (3) and then the polyetheramines (2).

The alcohol formed in the reaction is preferably removed, more preferably by distillation.

The preparation of the silicone copolymers (A) for the laundry-durable finishing of fibrous substrates is carried out preferably at temperatures from 0° C. to 100° C., more preferably 15° C. to 60° C. The method of the invention is carried out preferably under the pressure of the surrounding atmosphere, such as at about 1020 hPa, although it may also be carried out at higher or lower pressures.

The preparation of silicone copolymers (A) for the laundry-durable finishing of fibrous substrates may be carried out batchwise, semibatchwise, or continuously.

Examples of fibrous substrates which are treated with the compositions comprising the silicone copolymers (A) of the invention are natural or synthetically produced fibers, yarns, skeins, cables, sheetlike textile structures such as nonwovens, mats, woven, knotted or knitted textiles, leather and leatherette, and also hairs. Preferred fibrous substrates are textiles. For application of the composition of the invention, the textiles may take the form of individual fibers, fiber bundles, fiberfill fibers, yarns, carpets, fabric webs, or garments or parts of garments.

The textiles may consist of cotton, wool, copolymers of vinyl acetate, rayon, hemp, natural silk, polypropylene, polyethylene, polyester, polyurethane, polyamide, aramid, polyimide, polyacrylate, polyacrylonitrile, polylactide, polyvinyl chloride, glass fibers, ceramic fibers, cellulose or mixtures thereof.

Application to the fibrous substrates to be treated, preferably textiles, may take place in any desired manner which is suitable and widely known for the treatment of fibrous substrates, such as textiles—for example, by dipping, spreading, casting, spraying, rolling, padding, printing or foam application.

In the application, the composition of the invention may be combined with commonplace textile auxiliaries, such as, for example, binders comprising melamine resins or methylol resins, polyethylenes, polyurethanes, polyacrylates, polyvinyl alcohols, polyvinyl acetates, optical brighteners, flatting agents, electrolytes, wetting assistants, plastic resins, bleaches, antistats, dispersions of metal oxides, silicates, perfume oils, dyes and preservatives, defoamers or further hydrophobizing and oleophobizing assistants, such as perfluorinated hydrocarbons.

The products of the invention, furthermore, may be used with fabric softeners based on polysiloxanes and organic softeners such as anionic, cationic and nonionic softeners, and mixtures thereof.

These include functional and nonfunctional silicones, salts of the metal soaps, alkylpolysulfonates, sulfosuccinates and derivatives thereof, ester quats, sulfoalkylene fatty acid amides, alkylammonium sulfates, triethanolamine fatty acid esters, fatty acid polyglycol esters, fatty amine polyalkylene adducts, fatty acid amide polyalkylene adducts, and dispersions of paraffins, waxes, polyethylenes and polyesters.

The treated fibrous substrates, preferably textiles, are left to dry preferably at temperatures of 20° C. to 200° C., more preferably 100° C. to 180° C.

Laundry-durable finishing of the fibers means that properties with which the treated fibers, such as textiles, are endowed are retained even after laundering. Particular such properties are hydrophilicity and soft hand, but also color deepening, elasticity, scouring resistance, abrasion resistance, shrink resistance, crease recovery, and resilience.

The silicone copolymers (A) of the invention and, respectively the compositions comprising the silicone copolymers (A) of the invention have the advantage that they are easily emulsifiable and that the fibrous substrates treated with them, such as textiles, are hydrophilic and have a soft hand which, in contrast to the prior art, is retained after repeated laundering; therefore, the silicone copolymers (A) of the invention give the treated fibrous substrates a laundry-durable finish.

In the examples described below, all references to parts and percentages, unless otherwise indicated, are by weight. Moreover, all viscosity references are based on a temperature of 25° C. Unless otherwise indicated, the examples below are carried out at a pressure of the surrounding atmosphere, in other words about 1010 hPa, and at room temperature, in other words at about 20° C., or at a temperature which comes about when the reactants are combined at room temperature without additional heating or cooling.

Hereinafter:

Me stands for methyl radical and

Et stands for ethyl radical.

$$TA 187 = {N}^{1} \text{-} ( 3 \text{-} ( dimethylamino ) propyl ) \text{-} {N}^{3} , {N}^{3} \text{-} dimethylpropane \text{-} 1 , 3 \text{-} diamine ( available commercially from SIGMA \text{-} ALDRICH , MERCK , Darmstadt , Germany )$$

$$DA 102 - {N}^{1} , {N}^{1} \text{-} dimethylpropane \text{-} 1 , 3 \text{-} diamine ( available commercially from SIGMA \text{-} ALDRICH , MERCK , Darmstadt , Germany )$$

### Example 1 (Preparation of Copolymer P1)

A 1000 ml 3-neck flask with thermocouple, KPG stirrer and reflux condenser was charged with 474 g (60 mmol) of oxamidoester group-terminated dimethylpolysiloxane (7923 g/mol), hereinafter called oxamidoester-terminated silicone oil. At 22° C., with stirring and over the course of 10 minutes, 11.22 g (60 mmol) of TA 187 and subsequently 19.8 g (30 mmol) of JEFFAMINE® ED-600 (available from Huntsman Performance Products, Everslaan 45, B-3078 Everberg, Belgium) were added. This was followed by stirring for 30 minutes more. Thereafter the reaction product was freed from the resultant alcohol at 40° C. and a pressure of 20 hPa. This gave 502 g of an opaque, oligomeric product P1 having a molecular weight as determined by SEC of 20 050 g/mol.

### Example 2 (Preparation of Copolymer P2)

A 200 ml 3-neck flask with thermocouple, KPG stirrer and reflux condenser was charged with 109 g (10 mmol) of oxamidoester-terminated silicone oil (10 900 g/mol). At 22° C., with stirring and over the course of 10 minutes, 1.87 g (10 mmol) of TA 187 and subsequently 3.3 g (5 mmol) of JEFFAMINE® ED-600 (available from Huntsman Performance Products, Everslaan 45, B-3078 Everberg, Belgium) were added. This was followed by stirring for 30 minutes more. Thereafter the reaction product was freed from the resultant alcohol at 40° C. and a pressure of 20 hPa. This gave 113 g of an opaque, oligomeric product P2 having a molecular weight as determined by SEC of 23 378 g/mol.

### Example 3 (Preparation of Copolymer P3)

A 200 ml 3-neck flask with thermocouple, KPG stirrer and reflux condenser was charged with 109 g (10 mmol) of oxamidoester-terminated silicone oil (10 900 g/mol). At 22° C., with stirring and over the course of 10 minutes, 1.02 g (10 mmol) of DA 102 and subsequently 3.3 g (5 mmol) of JEFFAMINE® ED-600 (available from Huntsman Performance Products, Everslaan 45, B-3078 Everberg, Belgium) were added. This was followed by stirring for 30 minutes more. Thereafter the reaction product was freed from the resultant alcohol at 40° C. and a pressure of 20 hPa. This gave 112 g of an opaque, oligomeric product P3 having a molecular weight as determined by SEC of 24 111 g/mol.

### Example 4 (Preparation of Copolymer P4)

A 200 ml 3-neck flask with thermocouple, KPG stirrer and reflux condenser was charged with 109 g (10 mmol) of oxamidoester-terminated silicone oil (10 900 g/mol). At 22° C., with stirring and over the course of 10 minutes, 1.87 g (10 mmol) of TA 187 and subsequently 4.8 g (5 mmol) of JEFFAMINE® ED-900 (available from Huntsman Performance Products, Everslaan 45, B-3078 Everberg, Belgium) were added. This was followed by stirring for 30 minutes more. Thereafter the reaction product was freed from the resultant alcohol at 40° C. and a pressure of 20 hPa. This gave 115 g of an opaque, oligomeric product P4 having a molecular weight as determined by SEC of 19 366 g/mol.

### Example 5 (Preparation of Copolymer P5)

A 200 ml 3-neck flask with thermocouple, KPG stirrer and reflux condenser was charged with 109 g (10 mmol) of oxamidoester-terminated silicone oil (10 900 g/mol). At 22° C., with stirring and over the course of 10 minutes, 1.02 g (10 mmol) of DA 102 and subsequently 4.8 g (5 mmol) of JEFFAMINE® ED-900 (available from Huntsman Performance Products, Everslaan 45, B-3078 Everberg, Belgium) were added. This was followed by stirring for 30 minutes more. Thereafter the reaction product was freed from the resultant alcohol at 40° C. and a pressure of 20 hPa. This gave 114 g of an opaque, oligomeric product P5 having a molecular weight as determined by SEC of 21 042 g/mol.

### Example 6 (Preparation of Copolymer P6 in Analogy to Example 4 in US 2008/0075683 A1 for Comparative Experiment)

635 g of an α,ω-dihydrogenpolydimethylsiloxane with 0.052 wt % of Si-bonded hydrogen are mixed with 205 g of a polyether of the formula H₂C═CH—CH₂—(OCH₂CH₂)_{9.5}—OH. The mixture is heated to 100° C. and admixed with 0.28 g of a 2.7 wt % (based on elemental platinum) solution of a platinum-1,3-divinyl-1,1,3,3-tetramethyldisiloxane complex in an α,ω-divinyldimethylpoly-siloxane having a viscosity of 1000 mPa·s at 25° C., a solution of the catalyst known as Karstedt catalyst (and prepared as described in U.S. Pat. No. 3,775,452), whereupon the temperature of the reaction mixture rises by 19° C. and a clear product is formed. After an hour at 100 to 110° C., full conversion of the Si-bonded hydrogen is achieved. The polyether-polysiloxane intermediate has an OH concentration of 0.512 meq/g and contains 177 ppm of water.

200 g of this intermediate are mixed with 10.3 g of bis(dimethylaminopropyl)amine and the mixture is heated to 84° C.; 13.2 g of hexamethylene diisocyanate are metered in. The ratio of the NCO groups to the sum total of the organic functions reacting therewith is 0.998, or 0.97 if including water.

Without further catalysis, complete conversion of the isocyanate groups is achieved in an hour at around 90° C. in a slightly exothermic reaction. The polymer mixture contains 0.49 meq of basic nitrogen per gram.

32 g of this polymer are neutralized with a solution of 1.04 g of acetic acid in 8 g of diethylene glycol monobutyl ether.

The molar ratios of the reactants used in preparing the silicone copolymers of the invention, and also the molecular weight Mn of the resulting silicone copolymers P1 to P5, and their appearance, are summarized for Examples 1 to 5 in Table 1.

TABLE 1

| | Silicone | | | | | | | |
|---|---|---|---|---|---|---|---|---|
| | oxalate oil | | | | Amine stopper | | | |
| | Mn in [g/mol] | | JEFFAMINE ® | | TA | DA | Mn in | |
| Copolymer | 8000 | 11 000 | ED-600 | ED-900 | 187 | 102 | [g/mol] | Appearance |
| P1 | 2 | | 1 | | 2 | | 20 050 | opaque |
| P2 | | 2 | 1 | | 2 | | 23 378 | opaque |
| P3 | | 2 | 1 | | | 2 | 24 111 | clear |
| P4 | | 2 | | 1 | 2 | | 19 366 | opaque |
| P5 | | 2 | | 1 | | 2 | 21 042 | clear |

### Example 7 (Comparative Experiment)

25.0 g of the comparative copolymer P6 were mixed with 5.0 g of tridecyl alcohol ethoxylate with 10 EO (80% solution in water, available as LUTENSOL® TO 108 from BASF SE, Ludwigshafen) and then the mixture was slowly diluted with 70.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

### Example 8

20.5 g of copolymer P1 were mixed in 4.5 g of diethylene glycol monobutyl ether (available from Sigma-Aldrich Chemie GmbH, Taufkirchen, Germany) and 4.0 g of tridecyl alcohol ethoxylate with 5 EO (available as LUTENSOL® TO 5 from BASF SE, Ludwigshafen), and the mixture was then slowly diluted with 71.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

### Example 9

20.5 g of copolymer P2 were mixed in 4.5 g of diethylene glycol monobutyl ether and 4.0 g of tridecyl alcohol ethoxylate with 5 EO, and the mixture was then slowly diluted with 71.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

### Example 10

20.5 g of copolymer P3 were mixed in 4.5 g of diethylene glycol monobutyl ether and 4.0 g of tridecyl alcohol ethoxylate with 5 EO, and the mixture was then slowly diluted with 71.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

### Example 11

20.5 g of P4 were mixed in 4.5 g of diethylene glycol monobutyl ether and 4.0 g of tridecyl alcohol ethoxylate with 5 EO, and the mixture was then slowly diluted with 71.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

### Example 12

20.5 g of copolymer P5 were mixed in 4.5 g of diethylene glycol monobutyl ether and 4.0 g of tridecyl alcohol ethoxylate with 5 EO, and the mixture was then slowly diluted with 71.0 g of water and adjusted to a pH of 4.5 using 80% acetic acid.

The amount for use as indicated in Table 3 was prepared by dilution with water and applied with a pad mangle to a knitted cotton fabric and to a woven cotton/polyester blend fabric in accordance with the details from Table 2.

Performance Tests:

For textile finishing, a bleached, unfinished woven PES/CO 65/35 twill fabric with a basis weight of 215 g/m², an unfinished 100% CO terry toweling fabric with a basis weight of 460 g/m², and also an unfinished 100% CO interlock knitted fabric with a basis weight of 190 g/m² were used.

Serving as reference was a fabric padded with water and dried (=blank value).

The fabric was impregnated with the respective liquor, squeezed off with a two-roll pad mangle, stretched out, and dried in a MATHIS laboratory tenter frame at 150° C. for five minutes for the terry toweling fabric and three minutes for the knitted fabric and the twill fabric (see Table 2). The fabric was subsequently conditioned for at least 12 hours in a conditioning chamber at 23° C. and 62% atmospheric humidity.

TABLE 2

| | | Woven | |
|---|---|---|---|
| | Cotton knit | cotton/polyester | Cotton terry |
| | (interlock) | blend | toweling |
| Type of textile | (100% CO) | (65 PES/35 CO) | (100% CO) |
| Liquor pickup | 77% | 46% | 70% |
| (4 m/min; 4 bar) | | | |
| Drying and | 3 min; 150° C. | 3 min; 150° C. | 5 min; 150° C. |
| condensing | | | |

Method of Determination for the Results of the Use Examples:

Determination of Softness (Hand Evaluation):

Since the softness of textiles is greatly dependent on the subjective perception of the testers, only the boundary conditions, but not the evaluation, can be standardized. To ensure reproducibility nonless, the finished specimens were assessed and ranked in terms of their softness. For this purpose, four testers awarded points depending on the number of specimens tested, with the level of the point number correlating to the softness. The softest specimen receives the maximum point number, while the least soft specimen receives 0 points. The hand evaluation for a specimen is therefore calculated as the average value of the points scored by this particular specimen.

Determination of Droplet Absorption Time:

Following application of the silicone product, the finished specimen was stored for eight hours for acclimatization in a conditioning chamber at a temperature of 23° C. and an atmospheric humidity of 62%, and then a droplet of deionized water was placed on the taut fabric surface from a height of 1 cm, and a determination was made of the time taken for the fabric to absorb the water droplet—but no longer than three minutes (180 seconds).

Five determinations were carried out, and the results were averaged.

Determination of Laundering Integrity:

For the investigation of the wash fastnesses, all of the finished textiles were laundered together with around 3 kg of ballast fabric in a Siemens SIWAMAT 6143 household washing machine, on the coloreds wash program at 60° C., and spun at 1400 rpm. In this wash, a laundry surfactant was metered in as 36 g of a liquid laundry detergent of the “Spee Feincolor” brand from Henkel. All in all, 2 wash cycles each lasting 90 minutes were carried out, without drying in between.

The fabric was subsequently dried and conditioned for 12 hours in a conditioning chamber at 23° C. and 62% atmospheric humidity.

The fabric specimens were then again subjected to a comparison of softness.

For a number of use examples, Table 3 summarizes the results for the fabric finished by padding methods:

The textiles finished in accordance with the invention using oxamidoester-based silicone copolymers surprisingly exhibit a markedly improved laundry durability in comparison to the comparative product (silicone copolymer prepared via hydrosilylation and isocyanate bridging), demonstrated by the softness being still very good after laundering; their hydrophilicities are comparable, and even before laundering their soft hand is comparable.

TABLE 3

| | | | | | | Soft | Soft | Soft | Soft | Soft | Soft |
|---|---|---|---|---|---|---|---|---|---|---|---|
| | | | Droplet | | Droplet | hand, | hand, | hand, | hand, | hand, | hand, |
| | | | test, | Droplet | test, | cotton | cotton | cotton/ | cotton | cotton | cotton/ |
| | | | cotton | test, | cotton/ | terry | knitted | polyester | terry | knitted | polyester |
| | Solids | Amount | terry | knitted | polyester | toweling | fabric | blend | toweling | fabric | blend |
| Examples and | content | for use | toweling | cotton | blend | before | before | before | after 2 | after 2 | after 2 |
| Comparative | in [%] | in [g/l] | in [s] | in [s] | in [s] | washing | washing | washing | washes | washes | washes |
| Example 7 | 30 | 25.0 | 2 | 3 | 13 | 4 | 3 | 3 | 2 | 1 | 1 |
| (comparative) | | | | | | | | | | | |
| Example 8 | 30 | 25.0 | 1 | 5 | 14 | 3 | 4 | 3 | 4 | 4 | 4 |
| Example 9 | 30 | 25.0 | 2 | 4 | 13 | 2 | 2 | 3 | 5 | 4 | 4 |
| Example 10 | 30 | 25.0 | 3 | 3 | 14 | 4 | 3 | 4 | 4 | 3 | 4 |
| Example 11 | 30 | 25.0 | 1 | 7 | 12 | 2 | 3 | 2 | 3 | 4 | 2 |
| Example 12 | 30 | 25.0 | 2 | 7 | 16 | 4 | 4 | 4 | 3 | 3 | 4 |
| Blank value | | | 0 | 0 | 2 | 0 | 0 | 0 | 0 | 0 | 0 |

1.-7. (canceled)

8. A process for finishing of fibrous substrates with a laundry-resistant soft hand, comprising treating the fibrous substrates with a composition comprising silicone copolymer(s) (A) of the formula (I) 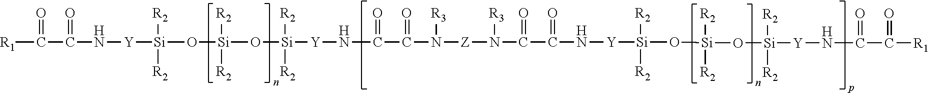
where
Y is identical or different and denotes a divalent hydrocarbon radical which has 1 to carbon atoms and optionally contains one or more heteroatoms,
Z is identical or different and denotes an organic radical which contains a polyoxyalkylene group and is divalent,
R¹ is identical or different and is a radical of the formula
—N(R⁴)—R⁵ (IV′)
or
—O—R⁵ (V′),
R² is identical or different and denotes a monovalent hydrocarbon radical which has 1 to 18 carbon atoms optionally containing halogen or oxygen atoms,
R³ is identical or different and is a hydrogen atom or a monovalent hydrocarbon radical having 1 to 20 carbon atoms,
R⁴ denotes a hydrogen atom, a C₁₋₁₈ alkyl radical or a hydrocarbon radical which has 4 to 18 carbon atoms and contains one or more oxygen or nitrogen atoms, and
R⁵ is a C₁₋₁₈ alkyl radical or a hydrocarbon radical which has 4 to 18 carbon atoms and contains one or more oxygen or nitrogen atoms,
or R⁴ and R⁵ in formula (IV′) together denote a divalent hydrocarbon radical which optionally contains one or more oxygen or nitrogen atoms,
n is an integer from 10 to 2000, and
p is an integer from 1 to 5.

9. The process of claim 8, wherein Z is a radical of the formula —(R⁶O)_{w}R7, where
R⁶ is identical or different and denotes a C₁-C₁₀ alkylene radical,
R⁷ denotes a C₁-C₁₀ alkylene radical,
w is on average 2.5 to 80, preferably 10 to 30.

10. The process of claim 8, wherein R⁶ is a C₂-C₃ alkylene radical and w is 10-30.

11. The process of claim 8, wherein
Y is a 1,3-propylene radical.

12. The process of claim 8, wherein R¹ is a radical of the formula —N(R⁴)—R⁵ (IV′).

13. The process of claim 8, wherein the treating composition(s) comprise aqueous emulsions comprising
silicone copolymer(s) (A),
at least one emulsifier (B) and/or coemulsifier (B′), and
water (C).

14. The process of claim 8, wherein the fibrous substrates are textiles.

15. The process of claim 8, wherein the compositions are applied to the fibrous substrates and the fibrous substrates thus treated are left to dry at temperatures of from 20 to 200° C.

16. The process of claim 15, wherein the fibrous substrates are textiles.

17. A fiber finishing composition, comprising a silicone copolymer (A) of claim 8.

18. A fiber finishing composition, comprising a silicone copolymer and emulsifier and/or coemulsifier of claim 13.
